(19) United States
(12) Patent Application Publication
(10) Pub. No.: US 2012/0224768 A1
(43) Pub. Date: Sep. 6, 2012

(54) SYSTEM AND METHOD FOR VISUAL SEARCH

(75) Inventor: Wai C. Lee, Olathe, KS (US)

(73) Assignee: Olive Root, LLC, Paola, KS (US)

(21) Appl. No.: 13/358,218

(22) Filed: Jan. 25, 2012

Related U.S. Application Data
(60) Provisional application No. 61/449,456, filed on Mar. 4, 2011.

(51) Int. Cl. G06K 9/62

(52) U.S. Cl. 382/165

(57) ABSTRACT

Systems and methods for visual search enable input of a digital image to retrieve images that complement the input image. A digital image is uploaded to a website or input into an application. This may be done from a mobile device having a digital camera. The digital image is analyzed and indexed according to its attributes, such as coloration, saturation, light, complexity, and presence of shapes or objects. Search criteria are structured according to the analyzed image and the indexed image is used as an input in a search of images in a database. Systems and methods enable searching for home décor items that complement an input image and enable inputting an image of one type of item (e.g., a piece of furniture) and finding items of another type (e.g., artwork) that complement the item in the input image.

### RELATED APPLICATION

This patent application claims priority benefit, with regard to all common subject matter, of earlier-filed U.S. Provisional Patent Application No. 61/449,456, filed Mar. 4, 2011, and entitled “SYSTEM AND METHOD FOR VISUAL SEARCH.” The identified earlier-filed provisional patent application is hereby incorporated by reference in its entirety into the present application.

### BACKGROUND OF THE INVENTION

### Field of the Invention

The present invention generally relates to visual search. The present invention is more particularly related to inputting an image or visually-related information in a server, such as via a website, and retrieving images that are complementary to the input image or information. More specifically, the present invention relates to electronically searching and finding home décor, such as artwork, furnishings, accessories, fabrics, window treatments, rugs, etc., which is complementary to an input image or input visual information.

Online visual search techniques and tools exist that enable an image to be uploaded and used to search and retrieve images of a matching item. Such tools are known to use color, shapes, and patterns so that, for example, a user can upload an image of an item of clothing, for example, that the user likes and find and purchase a matching or approximately matching item of clothing.

However, the need exists for new search visual search techniques and improved visual searching which enable a user to find images of items that are different or of a different type than the item in the uploaded image but which complement the uploaded image. For example, useful tools for uploading an image of a room and finding artwork that complements the room or for uploading an image of one type of item, such as a rug, and finding a complementary item, such as an item of artwork, are needed. Additionally, the need exists for enhanced user-interfaces which enable users to visually find items of interest and to enable purchase of those items. The present invention fills these and other needs.

### SUMMARY OF THE INVENTION

The present invention is a system and method for online visual search. According to the invention, a website is provided. The website provides an online visual interface for searching and displaying images, including images that correspond to products available for purchase. In particular, the present invention involves receiving, indexing and storing in a database images from a plurality of different feeds of images from a plurality of different sources. For example, according to the present invention, images of artwork from a first source are received and indexed. Images of home decorative accessories from a second source are received and indexed. Images of home furnishings from a third source are receiving and indexed. Images of rugs from a fourth source are received and indexed. Images of window treatments from a fifth source are received and indexed. It will be appreciated, that images of items of a similar type (such as artwork) may be received from multiple sources, and that images representative of other types of products may also be received and indexed.

Indexing images according to the present invention involves using information from the image. In particular, indexing images for search according to the present invention is directed to indexing items in a way that enables a search from an input image to find images that complement an input image (and are not direct matches of an input image). In this regard, for each digital image to be indexed, the present invention analyzes the image, computes image attributes by pixel, and partitions the colors in the image into color groups. According to one aspect of the present invention, indexing images to be placed in the database that is searched during a search involves eliminating neutral color information, such as color information pertaining to black, white or gray. Accordingly, each of gray, black and white is not used as a color group. Additionally, since each color group is, according to the invention, defined by a color value range of that color, the result is some color leniency within a color group when indexing images according to the present invention. Following the color analysis, the percentage of color in each color group is stored for that image. From this, an index based upon the determined image attributes is created by developing a bit-view for the image, where each bit in the bit-view corresponds to one color group and a bit is flagged if the image's percentage of the color corresponding to that bit exceeds a selected threshold.

Further, for each image to be indexed, the present invention determines additional image attributes such as brightness and complexity, and the image and determined image attribute information is stored in the database.

In accordance with the invention, a user accesses the website of the invention and inputs information useful for searching the database of images. In particular, the website provides a feature that enables the user to upload a photo to the website for use as an input image. Using this feature, for example, the user can upload a photo having colors to be used for inspiration in a search or can upload an image of a room for which home décor items are desired.

In accordance with the invention, the image may be uploaded from any client-side electronic device, such as a personal computer connected to the Internet, a mobile device, such as a cellular telephone, tablet computer, or communications-equipped digital camera, or an interactive or web-enabled television. In accordance with one particular aspect of the invention, a mobile communications device equipped for wireless communications includes a digital camera, a memory, and a touch screen input. A digital photo captured with the digital camera may be wirelessly transmitted from the mobile device for upload to the website of the present invention. The mobile communications device may include a software application, to enable this feature and for visually managing and displaying search results on the mobile device, comprised of a set of instructions, which is downloaded from the website of the present invention or another website, such as an online mobile applications store.

Upon receipt at the website of the present invention of an uploaded digital image, the code of the present invention analyzes the uploaded image using information from the image to index the image as described herein to create a bit-view of the input image. Additionally, additional attributes of the image, such as brightness and complexity, are determined. Additionally, according to the invention, the input image is further categorized, based upon its image attributes, as being one of (a) a multi-colored image; (b) a gray-scale image; or (c) a dominant color image. Depending on this categorization, a particular search criteria is used for finding complementary images. For a multi-colored input image (those images having at least a threshold percentage of a selected number of color groups), searching is performed by searching the database for images having a bit-view that matches the bit view of the input image. For a gray-scale input image (those images having at least a threshold percentage of color within an established gray color value range), such as for example a largely gray image, searching is performed by searching the database for images having at least one color group (other than black, white or gray which are not one of the color groups used) having at least a threshold percentage of color. For a dominant color input image (those images having at least a threshold percentage of one color group), such as for example a largely red image, searching is performed by searching the database for images falling within a preselected range of the determined dominant color group and a limited number of other color groups (such as one or two additional color groups) that meet a minimum threshold value.

Images returned as results in response to a search query according to the invention may be scored. In accordance with one aspect of the invention, for a multi-colored input image, information stored with the bit-view of each returned image is compared with similar information stored with the bit-view of the input image. In particular, for an image being compared with the input image, the difference between the percentage value of a each color group for the input image and its corresponding color group of the result image is determined and the absolute value of these is summed to arrive at an overall coloration difference raw score. This comparison with the bit view information of the input image is done for each of the images produced in the search results and the results are ranked from lowest overall coloration difference raw score to the highest overall coloration difference raw score. Then, a selected percentage of high raw score matches are eliminated (or only a selected percentage or number of low raw score matches are maintained).

Additionally, other criteria (such as brightness, complexity, etc.) are considered. In particular, according to the invention, when an input image is categorized as light (at least a threshold percentage of pixels are light), the present invention searches for images that with dark image attributes (at least a threshold percentage of pixels are dark), and vice versa. Additionally, using known algorithms for determining image complexity, when an input image is categorized as complex (or detailed), the present invention searches for images with image attributes that qualify it as non-complex (or simple, clean), and vice versa.

In accordance with another aspect of the present invention, the website of the present invention also provides a graphical user interface that enables a user to select inputs corresponding to color, brightness, saturation, hue, and/or index value (which is a value that is determined based upon a combination of color, brightness, saturation, hue, and complexity). In one embodiment, the graphical user interface is provided via a slide interface having a line or bar representing the range of possible inputs and a button that may be slid along the length of the line and stopped at a desired location to represent an input of that value. Additionally, in addition to the provision of multiple slide interfaces, the present invention enables the user to select whether these slide input interfaces are to be received individually (such as with an OR operation) or collectively, by selecting an AND operation. For example, a user may which to enable the interfaces as an OR operation, and first search for images with a significant amount of a single color, such as red. Results of the search based upon that input will be returned accordingly. Next, with the OR operation still enabled, the user may search for items that have a simple or clean (i.e., non-complex) appearance, and new results will be returned accordingly without reference to the original results based upon the red input. In contrast, the user may wish for these searches to be performed collectively or non-independently by enabling an AND operation for the searches. In such a case, the user would select the desired operation using user-controls and the search algorithm of the present invention would receive the inputs of the particular color (a red in our example) and complexity level (a simple, clean appearance in our example) and return results accordingly that are both within a range of the input red color AND within the range of the index value representative of the input indicative of a simple, clean appearance.

In accordance with another aspect of the present invention, online-accessible workspace and digital tools are provided via the website of the present invention to enable a user accessing the website to select colors and draw or scribble an input that is then used by the present invention to search the database of images. In particular, a user using the drawing and scribbling tool may select colors and digital utensils (such as paint brushes of different sizes, spray paint cans of different sizes, pens, pencils, paint cloths and sponges, an eraser, etc.) for creating a digital image. Additionally, the invention provides a second database of symbols, icons and images that can be selected and located (such as dragged and dropped) into the workspace. These symbols, icons and images may have associated textual tags that can be used as metadata to aid in the search of the first database of images. The present invention analyzes the generated drawing/scribble input and retrieves images from the first database of images to retrieve images of complementary items. In this way, a user can use his or her own creativity to generate an image that is used as an input inspiration for finding complementary or matching home décor.

Searches can be filtered with text inputs or by automatically filtering results by type of item (art, rugs, décor) and displaying those on a webpage by tabs.

Images retrieved from the database of images are retrieved according to the search criteria of the present invention are communicated for display via a webpage of the website. In accordance with one aspect of the invention, displayed images can be selected, resulting in retrieval and display of additional information about the selected image or the item corresponding to the selected image. In particular, the user may be navigated to a new webpage at a different website corresponding to the source of the item, where the browser session is redirected to the new website or a new tab is opened that directs the user to the new website at which additional information corresponding to the selected item is available and at which the selected item may be purchased.

Additionally, each or selected ones of the images displayed in the search results may include a button—such as a “more like this” button—enabling the user to find additional images that match or complement that particular image. In this way, a user can find more images that correspond to a particular image produced in the search results. In accordance with a particular aspect of the present invention, when the user has uploaded an image for input, it is assumed that the user desires to continue to look for images corresponding to the input image in addition to information corresponding to the newly selected image from the search results. Accordingly, in such a situation, upon selection of the “more like this”, the system will default to a search that employs an “AND” operation and uses information from the uploaded image and the newly selected image from the results. When, however, the user has not uploaded an image, but has searched using another available search feature (text input, color selection, complexity selection, etc.) and then the user selects more results like a particular image received in the initial results, the system of the present invention defaults to an OR operation and uses the newly selected image as the sole input for a subsequent search. According to the invention, user controls are provided which enable a user to change these default settings, such that, for example, information from an uploaded image will not continue to be used in a new search initiated from the results of an initial search or, alternatively, that initially input information from a text search, color selection, or complexity input, for example, will continue to be used in a new search initiated from the results of an initial search.

In accordance with another aspect of the present invention, a user can establish an account at the website of the present invention and generate online galleries of items using the images from the database of images. Applicant hereby references, and incorporates by reference in its entirety, U.S. patent application Ser. No. 12/412,136, entitled Systems and Methods for Organizing, Displaying and Distributing Digital Images and Selling Related Items, filed Mar. 26, 2009. An accountholder can browse and search the database of images and, using an online workspace, create a gallery of images. The gallery can be tagged by the user with appropriate text tags, such as tags that correspond with a theme of the gallery. For example, an accountholder may create a gallery of images corresponding to décoration of a particular room, such as a bedroom décorated in an island them. For example, the user may place in the gallery for display images of a bed, bedside furniture, artwork, a rug, lamps, candles and other décor items. Such a gallery may be tagged by the user with applicable textual tags, such as “bed room”, “bed”, “bedding” and “island”, “ocean”, “sea”, etc. Using privacy controls, the gallery may be maintained private, made available only to approved users, or may be published without any privacy settings. Additionally, subject to privacy controls, published galleries may be browsed and searched by others via the website and may be returned in search results. Such searching may be initiated visually, such as by uploading an image or employing the graphical user interfaces described above, such that galleries that meet search criteria using such inputs will be produced in search results. Alternatively, such searching may be initiated via text input, such as by text entry in a search field of one or more terms that match a textual tag applied to the gallery or by selection of search terms from a provided menu or list. It will be understood that a search may be initiated such that results are filtered by both visual and textual input. Visitors to a gallery may access additional information about an item as described and may purchase items in the gallery individually or collectively. In particular, selection of an image in a gallery navigates the user to a new page, and possibly a new website corresponding with the source of the item, at which additional information may be obtained and/or the item may be purchased.

According to one embodiment of the invention, an online shopping cart may be provided at the visual search website for enabling secure online purchase of items corresponding to images. In particular, a purchaser may place into the shopping cart for purchase a plurality of items from different sources and make a payment electronically via the site, such as by credit account, debit account, bank account, electronic check, etc. The source of the website may then place electronic orders and make payments to the various sources of items being purchased. Such ordering and payment features may use payment features such as offered by PayPars parallel payments or Amazon's flexible payment services.

In accordance with another aspect of the present invention, the visual search features of the present invention are distributed by enabling web developers to place a parameter in a script on the sites they develop. In particular, a script is provided that enables a web developer to place the path of a stored image in a script that includes a link to the visual search website of the present invention. For example, a web developer or web master of a website for rugs could display an image of a particular carpet on a web page and then, using the script of the present invention, enable the visual search engine of the present invention to access the image via the path in the script and use the image as an input into the search engine of the present invention to find, retrieve and make available for display on the web developer's website artwork that complements that rug in the image.

In accordance with another aspect of the invention, a browser plug-in is provided that enables a user to install the plug-in into his or her browser on a computing device. Once installed, the plug-in enables the user to right mouse-click (or the equivalent thereof) on an image resulting in the display of pop-up that includes a link to the web-based visual search engine of the present invention. Selecting the link to the visual search engine of the present invention results in the image being uploaded as an input into the visual search engine of the present invention.

### BRIEF DESCRIPTION OF THE DRAWINGS

FIG. 1 illustrates and system and system environment of the present invention;

FIG. 2 is a block diagram of a mobile device of the present invention;

FIG. 3a is a flow-chart generally illustrating a method of indexing and searching digital images according to the present invention;

FIG. 3b is a flow chart further illustrating a method of indexing a digital image according to the present invention when a digital image is used as an input;

FIG. 3c is a more detailed flow chart illustrating a search method according to the present invention when a digital image is used as a search input;

FIG. 3d is a flow chart illustrating a scoring method according to the present invention when a digital image is used as a search input;

FIG. 3e is a flow chart illustrating a search method according to the present invention when color is used as an input;

FIG. 3f is a flow chart illustrating a search method according to the present invention when an image complexity value is used as an input;

FIG. 3g is a flow chart illustrating a search method according to the present invention when an image brightness value is used as an input;

FIG. 4 illustrates a bit-view for indexing according to the present invention;

FIG. 5 illustrates a web page of an online search engine of the present invention and, in particular, illustrates an image generation graphical user interface of the present invention;

FIG. 6a illustrates a home page of an online visual search engine website of the present invention;

FIG. 6b illustrates a web page, including search results, of an online visual search engine of the present invention;

FIG. 6c illustrates a web page of an online visual search engine of the present invention and, in particular, illustrates graphical user interfaces of the present invention;

FIG. 7 is a flow chart of a search method of the present invention;

FIG. 8 is a flow chart of a method of marketing and distributing a visual search method of the present invention;

FIG. 9 illustrates a screen display of the method charted in FIG. 8;

FIG. 10 illustrates a flow chart of an affiliate marketing method using the invention illustrated in FIGS. 8 and 9 according to the present invention;

FIGS. 11a and 11b are flow charts of a method of employing browser plug-in according to the present invention;

FIG. 12 illustrates a screen display of the methods charted in FIGS. 11a and 11b; and

FIG. 13 illustrates screen displays and process flow for a mobile software application according to the present invention.

### DETAILED DESCRIPTION OF THE INVENTION

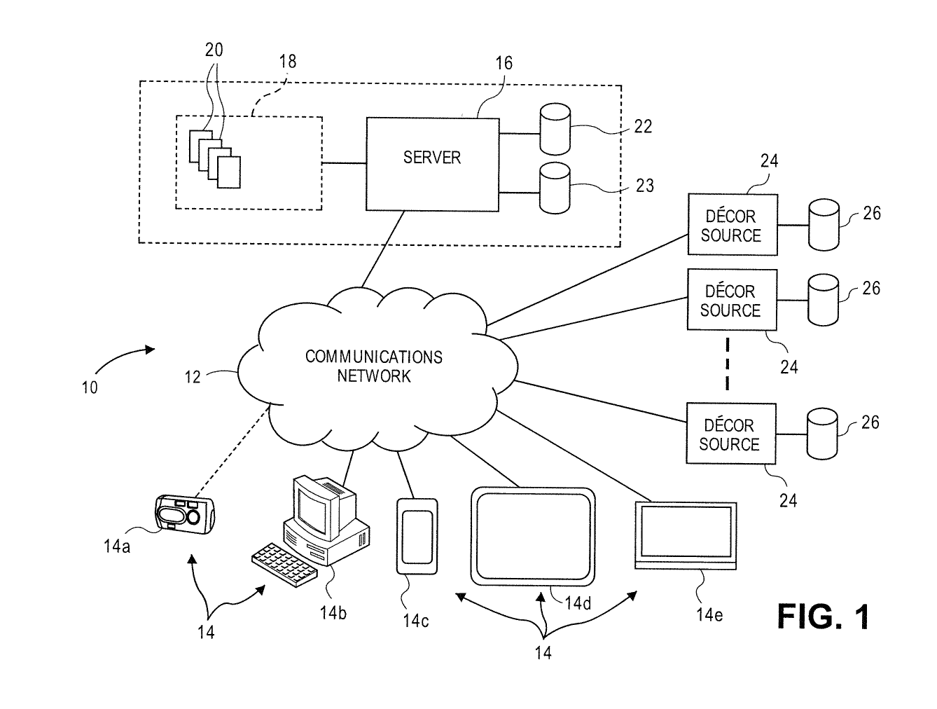

With reference initially to FIG. 1, a system and system environment of the present invention is illustrated generally by reference numeral 10. A communications network 12 connects electronic devices 14 to a server (or server bank) 16 that hosts a website 18 having navigable web pages 20. At least one database memory 22 stores indexed image files. Each of a plurality of sources 24 of home décor items has a website and webstore that are accessible via communications network 12, such as by the Internet. As illustrated, each source 24 has a corresponding database 26 for storing images of home décor items that corresponding source 24 makes available for sale.

It should be understood that communications network 12 may comprise any known type of communications network or a combination of networks and network types, including but limited wired networks, wireless networks, telephone networks, television networks, and fiberoptic networks and may employ a wide variety of communications standards and protocols for transmitting data, including but limited to protocols used on and by the Internet, such as a hyper text transfer protocol.

Electronic devices 14 may be any or a combination of a wide variety of electronic communications, media or computing devices. For example, illustrated are a camera 14a, a personal computer 14b, a mobile communications device such as a cellular telephone or handheld computing or media device 14c, a portable tablet computer 14d, and a laptop, notebook or netbook computer 14e. As illustrated, each of devices 14b-14e is connectable to communications network 12 and via communications network 12 to server 16 and sources 24. Preferably, this is accomplished via communications hardware and software located in the device 14. Additionally, as illustrated, camera 14a may include wireless communications capability to communicate directly via communications network 12 or may communicate contents stored therein (such as digital photos) via another electronic device 14, such as by transferring digital photos in camera 14a via a USB cable to personal computer 14b, so that personal computer 14b can in turn transmit digital photos received from the camera 14a via communications network 12.

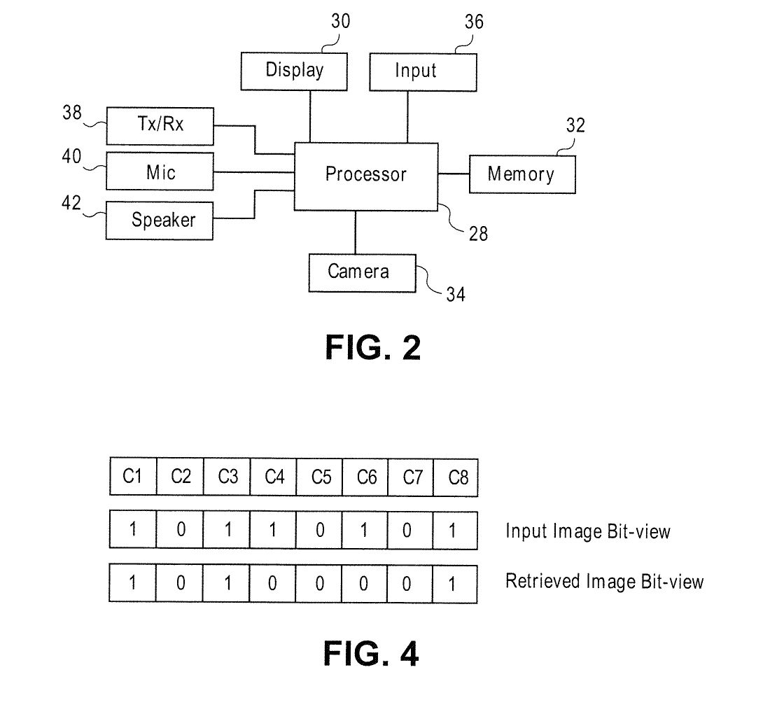

Additionally, each device 14b-14e may also include a digital camera or even multiple digital cameras, such as a rear-facing still frame digital camera and a front facing video camera, for example. In general, electronic devices 14 may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system 10. In various embodiments of the invention, electronic devices 14 may comprise a memory element, a communication component, a display, and/or a user interface. As illustrated in FIG. 2, a device 14 of the present invention has a processor 28. Connected to or in communication with the processor 28 are a display 30, a memory 32, a digital camera 34, and an input 36, such as a keypad or touch screen input. Additionally, in preferred embodiments, device 14 includes at least a wireless transmitter and receiver, denoted by reference numeral 38, and may include a microphone 40 and a speaker 42. The display 30 may comprise a graphical interface operable to display visual graphics, images, text, etc. in response to external or internal processes and commands. For example, the display 30 may comprise conventional black and white, monochrome, or color display elements including but not limited to CRT, TFT, LCD, and/or LED display devices. The display 30 may be integrated with the user input 36, such as in embodiments where the display is a touch screen display to enable the user to interact with it by touching or pointing at display areas to provide information to the device 14. The input 36 may comprise one or more functionable inputs such as buttons, switches, scroll wheels, a touch screen associated with the display, voice recognition elements such as a microphone, pointing devices such as mice, touchpads, tracking balls, styluses, a camera such as a digital or film still or video camera, an optical scanner, and combinations thereof. The user 36 may also include a speaker for providing audible instructions and feedback. Device 14 includes, stored in a memory of device 14, mobile operating system software, a mobile Internet browser, and software applications for executing functions. The device enables taking and storing digital photographs, storing contacts and other information, downloading and storing applications and games, wireless data communications, wireless voice communications if so equipped, and a variety of other functions. The device may include a GPS receiver (not shown) for determining location, an accelerometer (not shown), and a wide-variety of other components. In accordance with a particular aspect of the invention, and as described in more detail herein, device 14 of FIG. 2 is used for taking a digital photograph and wirelessly uploading that digital photograph from device 14 to server 16 via website 18.

Regarding server or server bank 16, server 16 may be a single server, a plurality of servers in physical proximity to each other, or a plurality of servers distributed in a network and capable of communication via communications network 12. For convenience, reference will be made to server 16, but it should be understood and appreciated that reference to server 16 may include a single server or multiple servers, located together or in disparate locations. Server 16 hosts website 18. Additionally, sever 16 includes a memory that stores search engine software in accordance with the present invention. As described herein, search engine software searches database 22 based upon inputs received at website 18. In embodiments of the invention, the processor 16 implements a computer program and/or code segments of the computer program to perform functions described herein. Code segments stored on a computer-readable medium are executed by processor 16 to carry out computer-implemented instructions for receiving and analyzing data indicative of a visual input and, based upon that input, searching a database of indexed images and selecting and retrieving from the database of images certain images that meet search criteria specified in the code segments of the present invention. The computer program may comprise a listing of executable instructions for implementing logical functions in the processor 16. The computer program can be embodied in any computer readable medium for use by or in connection with an instruction execution system, apparatus, or device, and execute the instructions. In the context of this application, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semi conductor system, apparatus, device or propagation medium. More specific, although not inclusive, examples of the computer readable medium would include the following: a portable computer diskette, a random access memory (RAM), a read only memory (ROM), an erasable, programmable, read only memory (EPROM or flash memory), and a portable compact disk read only memory (CDROM), and combinations thereof.

The computer readable medium and the computer program embodied with processor 16 may be remotely accessible, such as via a Web browser over the Internet. The various actions and calculations described herein as being performed by or using the computer program may actually be performed by one or more computers, processors, or other computational devices, independently or cooperatively executing portions of the computer program.

The memory element may be integral with the server 16, a standalone memory, or a combination of both. The memory element may include, for example, removable and non removable memory elements such as RAM, ROM, flash, magnetic, optical, USB memory devices, and/or other memory elements. The memory element may store one or more of the databases 22 or user profiles of registered gallery users an creators described herein, code segments for accessing and using the databases 22 or user-profiles, and/or other data for instructing the server 16 to perform the functions and methods described herein. The memory element may comprise a plurality of memory elements located within the server 16 and/or located at a plurality of locations and accessible remotely via the communication network 12.

Regarding sources 24, each source 24 maintains an online website and web store (with online shopping cart) for selling décor items. In that regard, each source 24 may sell a single type of home décor item or may sell a variety of different types of home décor items. Additionally, a source 24 may make its items available for purchase online with delivery by mail or courier and/or a source 24 may have one or more physical retail locations at which items purchased online may be picked-up. Examples of home décor items sold by sources 24 may include, but are not limited to, framed and unframed artwork, such as table art and wall art, printed photography, mirrors, frames for artwork and photos, flooring materials, tile, wood, carpets and rugs, lamps, candles, bedding, pillows, window treatments, fabrics, furniture, furnishings, cabinetry, decorative columns and posts, hardware such as door knobs, drawer handles, and hinges, artificial floral arrangements, appliances such as kitchen and laundry appliances, wall paper, paint, and home décor accessory items, such as shelves, plates, statues, figurines and other decorative items.

In accordance with the invention, a system and method for searching a database of images is provided. In particular, code segments that define a search strategy and criteria of the present invention are stored at server 16 and graphical user interfaces of the present invention are presented via website 18 of the present invention for enabling a visitor to website 18 to make initiate a search of database 22. In particular, the present invention provides a system and method for searching with one or more visual inputs, such as an input digital photograph, a color input, an input indicative of a hue, saturation, or brightness, or a visual complexity-level input, as described in detail herein.

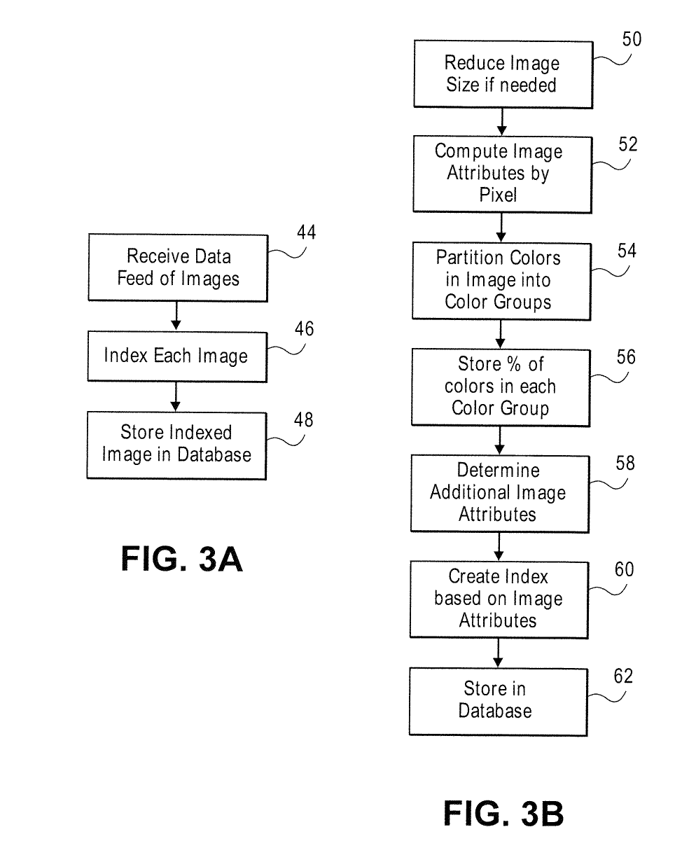

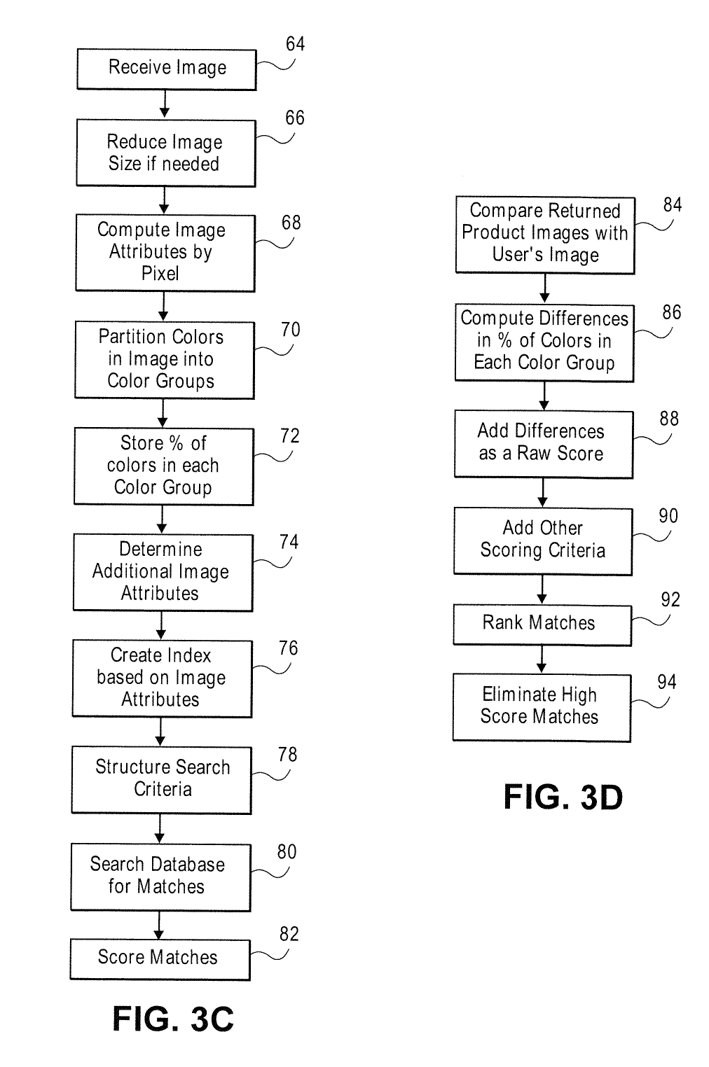

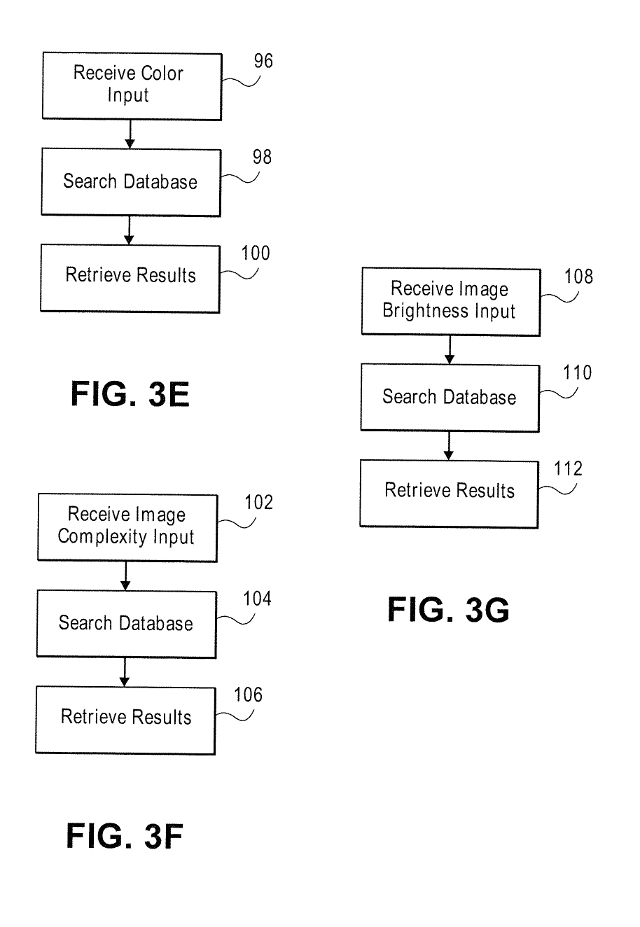

With reference to FIGS. 3a-3g, an online visual search engine method of the present invention is illustrated and described.

FIG. 3a illustrates a method according to the present invention for indexing images for storage in database 22. The images to be indexed are obtained from data feeds provided by sources 24. Preferably, each image is an image of a home décor item that is available for purchase at its corresponding source 24. In particular, at step 44 a data feed of images from a source 24 is received at server 16. This may be accomplished in any conventional fashion, such as by a file transfer protocol. At step 46, server 16 processes code segments on the received data feed to index each image according to a computer-implemented image indexing method of the present invention. At step 48, the indexed images are stored in database 22.

FIG. 3b illustrates in more detail the computer-implemented image indexing method of the present invention as referenced at step 46 in FIG. 3a.

At step 50, an image from a data feed of images to be indexed is reduced in size if the image exceeds a selected threshold size. Reducing the image in size, as necessary, improves computation time and provides consistency in color study between images. Image compression techniques are well known.

At step 52, the image to be indexed is analyzed. In particular, attributes of the image are computed from a pixel scan of the image. For example, processor 16 employing computer executable instructions of the present invention determines color information, level of complexity in the image (i.e., level of details), and brightness information, such as the average number of light pixels and the average number of dark pixels. It should be understood that determining the attributes of the image may involve determining Red, Green, Blue (R,G,B) values and/or Hue, Saturation, and Brightness (H,S,L) values (or H,S,V values), and/or any combination of these. In accordance with a particular aspect of the present invention, an R,G,B value is determined for each pixel. In accordance with one aspect of the invention, when an image is not formatted to obtain H,S,L values, processing is performed to convert R,G,B values to H,S,L values. Image complexity determinations are well known and a variety of known techniques may be used for making this determination. Additionally, during this pixel scan of the image, in addition to color information, additional information such as image complexity (level of image detail), brightness, average number of pixels defined as light, and average number of pixels defined as dark is determined.

At step 54, the colors in the image are partitioned into a discreet number of color groupings. The number of color groupings may vary depending on the implementation of the invention. For illustrative purposes herein, eight color groupings are used and described. However, it should be understood that another number of color groupings, such as ten, twelve, sixteen, twenty-four or another number may be used. In accordance with the invention, neutral colors such as black, white and gray are not used in this partitioning step. In accordance with the invention, those neutral colors are purposely ignored. Accordingly, for example, eight color groupings might be Red (R), Green (G), Blue (B), Orange (O), Pink (P), Yellow (Y), Indigo (I) and Violet (V) such that an image with a certain percentage of pixels having a particular color will be flagged as having that color. For example, H=Hue defines colors from zero (0) to one (1) so, for example, 0-0.15 is a defined as a first color, 0.15-0.3 is defined as a second color, etc.

At step 56, a value corresponding to a percentage of pixels within a particular color in the input image is stored. For example, if ten percent (10%) of the pixels in the analyzed input image are Red (R), then that percentage is stored in the Red color grouping for this image.

At step 58, additional image attributes (complexity level, saturation (S), lightness (L), appearance of predetermined shapes, etc.) are determined.

At step 60, an index is created based on the attributes of the image and, in particular, based on the information related to the color groupings of the image. In accordance with the invention, the created index is a bit-view. FIG. 4 illustrates a bit-view in accordance with the invention. The bit-view has a number of bits. Each bit corresponds to one of the color groupings used when indexing images according to the invention. As illustrated, a generic bit-view has eight (8) bits corresponding to generic colors C₁, C₂, C₃, C₄, C₅, C₆, C₇ and C₈. More particularly, a bit view using the eight (8) colors used in the example herein has bits corresponding to colors Red (R), Green (G), Blue (B), Orange (O), Pink (P), Yellow (Y), Indigo (I) and Violet (V). In accordance with the invention, a threshold color percentage level is set for each bit, such that when a color percentage value corresponding to a color group meets the threshold (such as greater than 2%), then the bit is set or flagged with a one (“1”). When, however, a color percentage value corresponding to a color group does not meet the threshold (such as when, for example, the threshold is two percent (2%) and the color percentage value for that color is less than 2%), then the bit corresponding to that color is set or flagged with a zero (“0”). Accordingly, as illustrated, using an example in which the minimum color threshold value is two percent (2%), a bit-view in which color groupings Green (G), Blue (B), Yellow (Y) and Violet (V) meet the threshold would have a bit-view of -01100101-. I

At step 62, the image index along with color grouping information (including color percentages) and additional image attributes (e.g., complexity level, brightness, etc.) are stored in database 22. In particular, in accordance with the present invention, in addition to storing both a high resolution version and a low resolution version of the image, stored for each color group are the percentage of pixels in that color group, the average color of the color group, the percentage of pixels within a selected Saturation (S) range and the average saturation (S) for that color group, and similar information for the Light (L) value. Also stored for each image is the dominant color for that image.

In accordance with the present invention, at least one input indicative of a search criterion is received at website 18. As described herein, that input could be a text input, a color input, an image-complexity input, an input indicative of hue, saturation or brightness, and/or an uploaded image input. When the input is an image, such as may be received via uploading from a device 14 via communications network 12 to server 16 via the website 18, the uploaded image is indexed by server 16 executing computer code according to the computer-implemented image indexing method illustrated and described in FIG. 3b. Server 16 processes code to execute a search of database 22 for images that meet the input search criteria. At least a portion of the images that meet the input search criteria and are therefore found in the search are retrieved as search results and communicated via communications network 12 for display on a display of the device from which the search query was initiated, such as display 30 of device 14 of FIG. 2. The results may be filtered and sorted, respectively, based upon programmed automatic filters or user-input.

More specifically, with reference to FIG. 3c, receipt of a search request at website 18 and the computer-implemented search method of the present invention is illustrated and described. In particular, FIG. 3c illustrates a method of the present invention for processing an input image and using that input image for searching according to the method of the present invention.

At step 64, an image is received. The image may be received in any of the manners herein described, such as by uploading an image to website 18 of the present invention from an electronic device 14.

At step 66, the size of the image is reduced to a preselected threshold size, as necessary. As described, reducing the size of the image, as necessary, improves processing time and provides consistency in color study between images.

At step 68, the input image is analyzed. In particular, attributes of the input image are computed from a pixel scan of the image. For example, processor 16 employing computer executable instructions of the present invention determines color information, level of complexity in the image (i.e., level of details), and brightness information, such as the average number of light pixels and the average number of dark pixels. It should be understood that determining the attributes of the image may involve determining Red, Green, Blue (R,G,B) values and/or Hue, Saturation, and Brightness (H,S,L) values (or H,S,V values), and/or any combination of these. In accordance with a particular aspect of the present invention, an R,G,B value is determined for each pixel. Image complexity determinations are well known and a variety of known techniques may be used for making this determination.

At step 70, the colors in the input image are partitioned into the discreet number of color groupings used when indexing the images for storage in database 22. As before, in accordance with the invention, neutral colors such as black, white and gray are not used in this partitioning step. In accordance with the invention, those neutral colors are purposely ignored. Following the example previously used, the colors in the input image are partitioned into the eight color groupings of Red (R), Green (G), Blue (B), Orange (O), Pink (P), Yellow (Y), Indigo (I) and Violet (V). As stated, it will be understood that a different number of colors and/or different colors may be used for the color groupings. For example, H=Hue defines colors from zero (0) to one (1) so, for example, 0-0.15 is a defined as a first color, 0.15-0.3 is defined as a second color, etc.

At step 72, a value corresponding to a percentage of pixels within a particular color in the input image is stored. For example, if ten percent (10%) of the pixels in the analyzed input image are Red (R), then that percentage is stored in the Red color grouping for this image.

At step 74, additional image attributes (complexity level, saturation (S), lightness (L), appearance of predetermined shapes, etc.) are determined.

At step 76, an index is created based on the attributes of the image and, in particular, based on the information related to the color groupings of the image. In particular, a bit-view (as illustrated in FIG. 4) for the input image is created as described above.

At step 78, using the image attributes determined for the input image, the input image is categorized for purposes of structuring search criteria. In particular, the input image is categorized, based upon its image attributes, as being one of (a) a multi-colored image; (b) a gray-scale image; or (c) a dominant color image. In accordance with the invention, this determination is made by setting percentage thresholds. For example, a gray scale image may be an image that has a selected threshold of pixels being one of black, white or gray, a dominant color image may be an image that has at least 30% of its pixels being a common color, and a multi-colored image could be all other images. It will be appreciated that the manner of defining these categories can be adjusted or programmed to change the settings/parameters used for defining an image into a category.

At step 80, processor 16 processes executable software instructions or code strings to search database 22 for images that complement the input image. Depending on this categorization, a particular search criteria is used for finding complementary images. For a multi-colored input image (those images having at least a threshold percentage of a selected number of color groups), searching is performed by searching the database for images having a bit-view that matches the bit view of the input image. For a gray-scale input image (those images having at least a threshold percentage of color within an established gray color value range), such as for example a largely gray image, searching is performed by searching the database for images having at least one color group (other than black, white or gray which are not one of the color groups used) having at least a threshold percentage of color. For a dominant color input image (those images having at least a threshold percentage of one color group), such as for example a largely red image, searching is performed by searching the database for images falling within a preselected range of the determined dominant color group and a limited number of other color groups (such as one or two additional color groups) that meet a minimum threshold value.

At step 82, images that match the search criteria are scored by processor 16 processing executable software instructions or code strings. This scoring step and related methodology of the present invention is illustrated and described in more detail below in conjunction with FIG. 3d.

With additional reference to FIG. 3d, scoring of images returned in the search illustrated and described in conjunction with FIG. 3c is illustrated and described.

In particular, at step 84, the product images returned in the search are compared with the with user's input image.

At step 86, the electronic processor computes the absolute value of the differences in the percentage of colors in each color grouping.

At step 88, all the differences determined at step 86 are summed as raw score.

At step 90, other scoring criteria may be used (such as computing and adding the absolute value of differences in complexity, image brightness, and other criteria (as may be based on color theory, user input criteria, and décorating best practices).

At step 92, the returned are ranked based on the difference calculations performed.

At step 94, matches above a particular number of matches or above a selected difference are eliminated.

In accordance with additional aspects of the invention, additional progressive functionality is enabled. In particular, in accordance with the invention, the search algorithm first looks for the most specific results relevant to a search and then expands to less specific or matching results. For example, a search by a user looking for an exact color match first looks at the high resolution images for the particular color being searched. If that color match is not found, searching advances to look for a change of shade of the color searched. Or, for example, a search based upon a multi-colored image may give up one color in the search process.

Additionally, filtering functionality is provided that enables provided search results to be further filtered. For example, the images may be automatically filtered such that too many results are filtered with the converse of an input such that, when an input image is light, the invention filters out light images leaving dark images and vice versa. Similar, when an input image is relatively simple the invention filters out simple images and leaves images that are more complex. Provided search results can be further filtered or subsequently sorted by price of a corresponding item, date range (such as the period of a piece of artwork), or other criteria.

The foregoing describes primarily the occurrence of a digital image having been used as the input for searching. As described, in accordance with the invention, icons indicative of color, complexity, or brightness are provided as alternate inputs. In this way, a user who does not have an image to input or does not select a provided image as a search input can select a color, a complexity level, and/or brightness for input.

FIG. 3e illustrates a computer-implemented search method of the present invention when a color is used as an input. At step 96, a color input is received at website 18. Such an input may be input by a visitor to the website by selecting a color tile from a grid of colors, or by entering an identifier, such as an R,G,B identifier, for a particular color. At step 98, server 16 processes computer code to execute a search of the images in database 22 using the input color for images in database 22 that are within a range of the input color. At step 100, at least a portion of the images that meet the search criteria including the input color are retrieved and communicated via communications network 12 for display on a display of the device from which the search query was initiated, such as display 30 of device 14 of FIG. 2.

FIG. 3f illustrates a computer-implemented search method of the present invention when a value corresponding to an image complexity is used as an input. At step 102, a value indicative of an image complexity is received at website 18. Such an input may be input by a visitor to the website by selecting an icon indicative of image complexity, such as “simple” for clean images without a lot of detail or “sophisticated” for more complex images with greater detail or, as described herein, by using an adjustable interface such as a slide button interface. At step 104, server 16 processes computer code to execute a search of the images in database 22, using the input image complexity value, for images in database 22 that are within a range of the input image complexity value. At step 106, at least a portion of the images that meet the search criteria including the input image complexity value are retrieved and communicated via communications network 12 for display on a display of the device from which the search query was initiated, such as display 30 of device 14 of FIG. 2.

FIG. 3g illustrates a computer-implemented search method of the present invention when a value corresponding to an image-brightness is used as an input. At step 108, a value indicative of image brightness is received at website 18. Such an input may be input by a visitor to the website by selecting an icon indicative of brightness or by adjusting an icon indicative of image brightness. At step 110, server 16 processes computer code to execute a search of the images in database 22, using the input value indicative of brightness, for images in database 22 that are within a range of the input brightness value. At step 112, at least a portion of the images that meet the search criteria including the input brightness value are retrieved and communicated via communications network 12 for display on a display of the device from which the search query was initiated, such as display 30 of device 14 of FIG. 2.

With reference now to FIG. 4, a bit-view for indexing according to the present invention is illustrated and described.

FIG. 4 illustrates a generic 8-bit bit-view of colors labeled by bits C1 for a first color through C8 for an eighth color. Also illustrated is an example of a bit-view of an input image and a results image which can be compared.

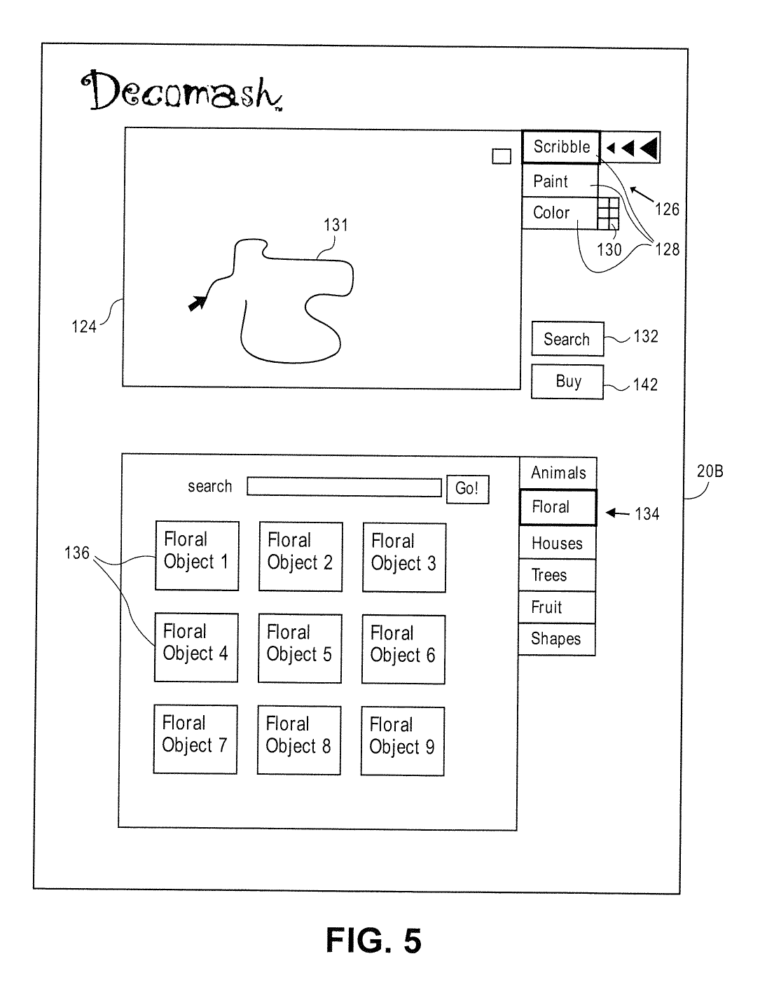

With reference now to FIG. 5, a web page and graphical user interface associated with a draw and scribble user interface of the present invention is illustrated and described.

FIG. 5 illustrates a web page 20B of search engine website 18 of the present invention. Web page 20B presents an online-accessible user work area 124 and a menu 126 of digital tools 128 to enable a user to digitally draw, scribble and/or paint in the work space 124. Depending on the device 14 from which user input is made, input may be made using a computer-mouse, a finger or stylus on a touch screen, or a finger or stylus on a touch sensitive pad. Such online digital scribbling and drawing tools are known. Digital tools 128 enable a user to selects different types of tools (paint brush of different sizes, spray paint cans of different nozzle sizes, pens and pencils of different sizes, erasures, etc.) for creating imagery in work space 124. Additionally, a color palette 130 enables the user to select different colors to create a multi-colored image 131 in the digital work space 124.

In accordance with a particular aspect of the present invention, a database 23 of visual objects is provided and accessible by search, such as search field 132 or menu input from menu 134. Such visual objects are small files of an image or object in a digital format, such as .gif, .png, .jpg, etc. In this way, a user who is generating imagery in work space 124 may search and select visual objects 136 for inclusion in the generated image, thus greatly enhancing the generated image and enabling detail that is perhaps beyond the ability of the user or the available tools to generate. Such a selection may be made by dragging and dropping one or more visual objects 136 into the work space 124 or by selecting an “add” button (not shown) corresponding to an object 136. The invention also includes the ability to erase or remove an object 136 that has been added to work space 124.

Upon completion of a generated image, the user may select to search for home décor using the generated image 131 as inspiration by selected search button 140. When search button 140 is selected, the image 131 is used as an input image and the process of indexing image 131 and searching for corresponding results from database 22 is carried out as described herein. Alternatively, a user may select to purchase image 131 by selecting buy button 142. Selection of buy button 142 will navigate the user to a shopping cart at website 18 or another, affiliate website, that enables selection of size (for example, in inches, 3×5, 4×6, 5×7, 6×8, 12×12, 11×14, custom size, etc.), framing and matting options, type (for example, print on photographic paper, acid free paper, canvas, etc.), presents pricing and shipping, delivery or pick-up options, and enables online check-out and payment.

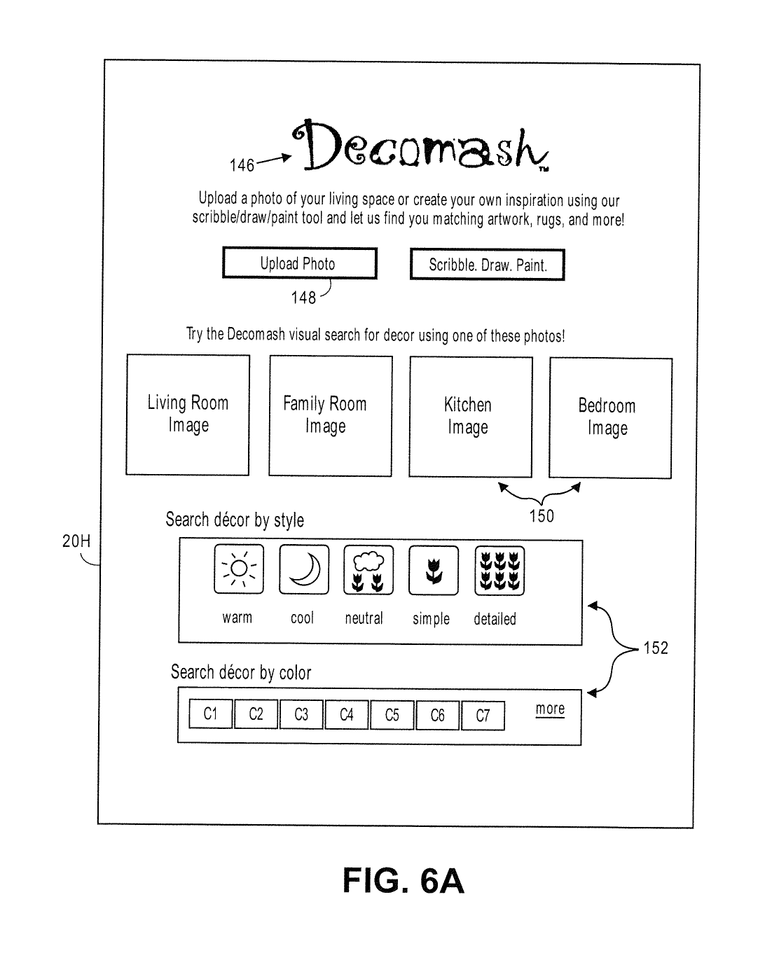

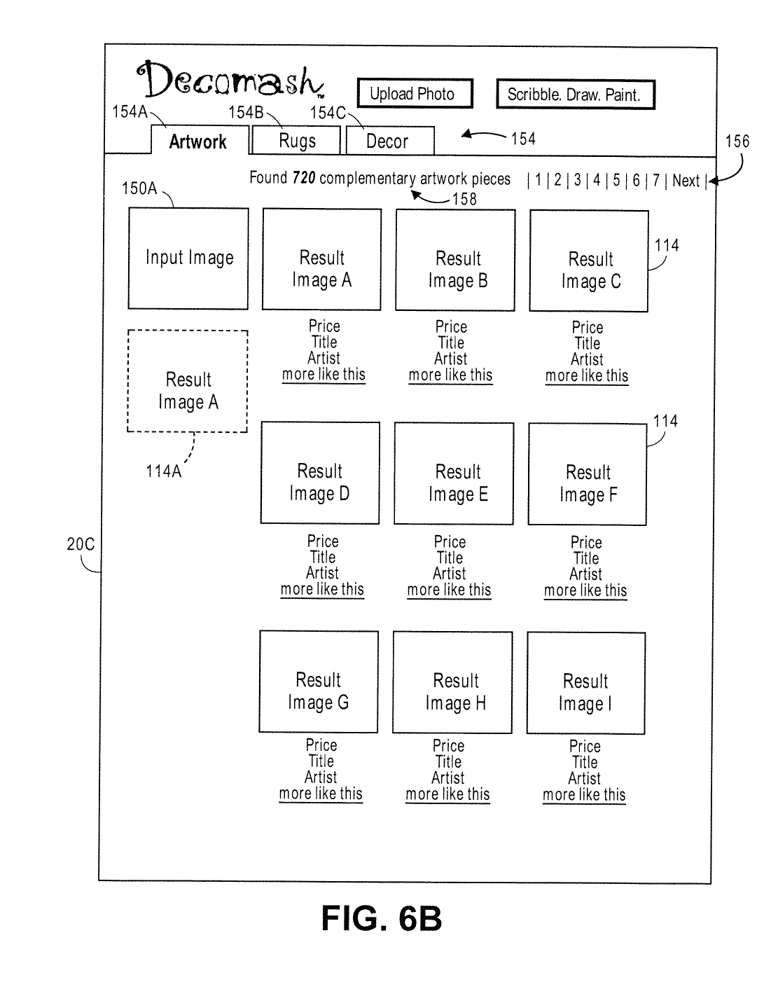

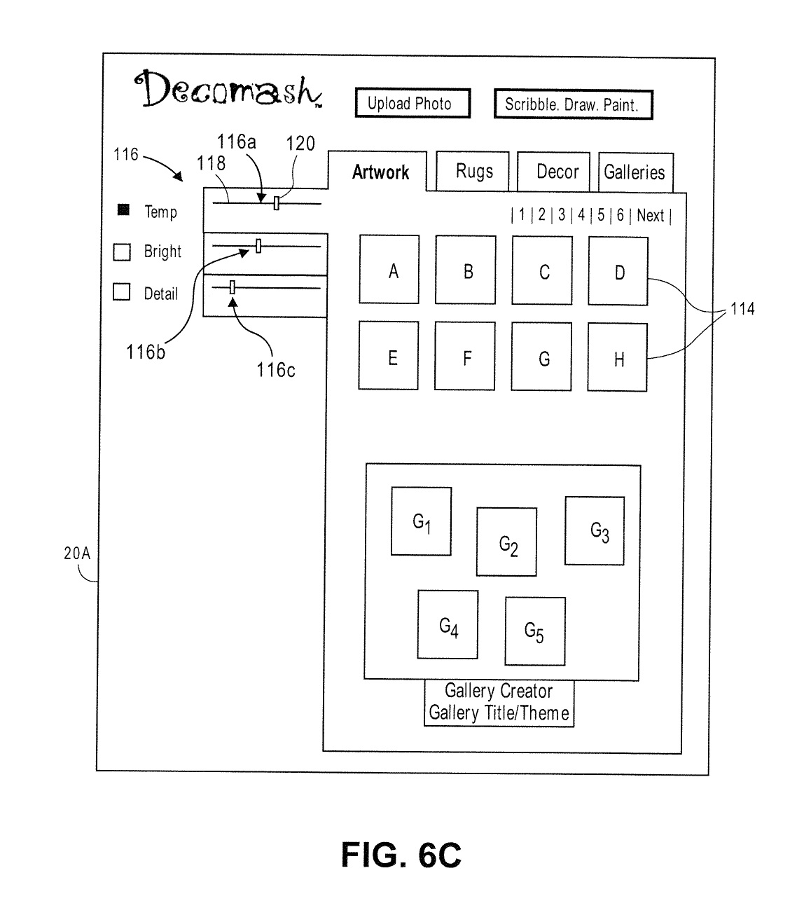

With reference now to FIG. 6, web pages of website 18 of the present invention are illustrated and described.

FIG. 6a is illustrative of a home page 20H of visual search engine website 18 of the present invention. Home page 20H illustrates a trademark and logo 146, Decomash™ associated with the source of the website 18, an upload photo button 148 for uploading a digital photo or image from a device 14 to use as an input for search, a plurality of preselected digital images 150 for use as inputs for searching for home décor items from database 22, input links 152 for use to search for home décor items from database 22 by color, brightness, visual complexity, or color/temperature category.

FIG. 6b is illustrative of a web page 20C, of website 18 of the present invention, that displays results from a search of database 20, according to the principals and methods of the present invention as described herein, using a digital image as an input for the search. In particular, as illustrated, preselected image 150A was selected as an input for search and is shown in the margin of web page 20C to signify that it was used as the search input. Digital images 114 are displayed as search results retrieved from database 22. In particular, search results are displayed by tab, with home décor items of a given type being categorized under a corresponding tab. As illustrated, web page 20C presents tabs 154 and, in particular, tab 154A labeled “Artwork”, tab 154B labeled “Rugs”, and tab 154C labeled “Décor”. It will be appreciated that other tabs could be provided to correspond to other types of home décor items produced in the search results. As illustrated, web page 20C is presenting images 114 corresponding to artwork and there are additional pages of results, as indicated by reference numeral 156 and an indication of the number of results returned, as indicated by reference numeral 158.

With reference now to FIG. 6c, a graphical user interface for visually selecting inputs for a computer-implemented search is illustrated and described.

FIG. 6c illustrates a webpage 20A of website 18 of the present invention, that presents search results of images 114 retrieved from database 22, where each image presents an item of décor and includes a corresponding electronic link for linking with a web page at which additional information regarding the item displayed in an image is available. In that regard, the corresponding web page to which an image links may be a web page 20 at search engine website 18 of the present invention or, alternatively, may be a web page at another website associated with a source 24. In accordance with a particular aspect of the present invention, a source associated with the search engine website 18 of the present invention 18 may receive a fee per click for generating traffic to a source 24 and/or for an aggregate number of impressions in a period of time. Additionally, or alternatively, the source associated with the search engine website 18 of the present invention may receive an affiliate commission for purchases made by visitors to a website of a source 24 from a link initiated at website 18.

The displayed images in FIG. 6c are the results of a search performed in one of the manners herein described. A graphical user interface area 116 presents slide interfaces that enable a visitor to the webpage 20A of website 18 to adjust one or more of the interfaces to initiate a new search of images from database 22. In particular, graphical user interface area 116 has a number of slide interfaces represented by reference numerals 116a, 116b and 116c, each represented by a line 118 and a moveable button 120. Button 120 is movable by dragging the button 120 along line 118 with the aid of a computer mouse or, in the case of a touch screen implemented embodiment, with a swipe of a finger or stylus. By moving and stopping the button 120 on its corresponding line 118, processor 118 recognizes the resting location of the button as an input for that particular slide interface. In particular, graphical user interface area 116a is indicative of a temperature input, where the color continuum as been arranged to match temperature references or zones. For example, from hot to cold, a color continuum of dominant colors may be—red, orange, yellow, green, blue, purple—with variations of those colors arranged along the continuum according to their R,G,B values. Sliding the button 120 of user interface 116a to the “hot” end of its corresponding line 120 will result in the search engine of the present invention searching for and retrieving images with color content within a range of the color input. User interface 116b corresponds to a brightness input and operates in a similar manner, but uses brightness value as an input for searching the images of database 22. User interface 116c operates in a similar manner, but uses a value corresponding to complexity as an input for searching the images of database 22. It should be understood that additional interfaces may be provided.

In accordance with the invention, user interfaces 116a, 116b and 116c may be used independently or together. For example, in one embodiment, user interfaces 116a, 116b and 116c default to operating independently, such as in a logical OR operation, such that search results will be retrieved only for the particular user interface activated. A particular user interface 116a, 116b, or 116c may, for example, be activated simply by being the last user interface which has received an input. Alternatively, two or more user interfaces 116a, 116b and 116c may be used as simultaneous inputs, such as in an AND operation, by user selection of corresponding check-boxes 122.

It will be appreciated that the visual search engine website of the present invention enables display of results of a second search that is subsequent to the search using preselected image 150a as presented in FIG. 6b. In particular, selection of image 114a, such as by tapping on a touch screen or mouse clicking the image, on web page 20C of FIG. 6b results in image 114a being used as an input for searching database 22. The image 114a may be presented adjacent originally input image 150a. Additionally, web page 20C displays new results of a search that used image 114a as its input.

In accordance with one embodiment of the invention, in one embodiment of the invention, selecting an image 114 received in search results as a new input for search will result in the newly selected image, such as image 114a in the example of FIG. 6f, to be used exclusively as the input for a new search of database 22.

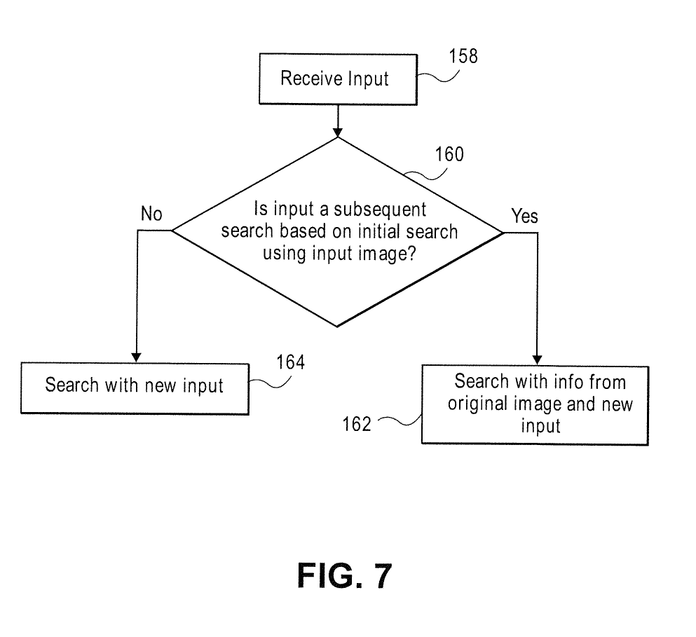

In another embodiment of the invention, selection of an image 114 received in search results as a new input for search will result in aspects of the newly selected image, such as image 114a in the example of FIG. 6b, to be used in an input for a new search of database 22, but the search method of the present invention will retain information from the originally input image, such as image 150a in the example of FIG. 6b. In this regard, search methods of the present invention may retain one or any combination of textual tags from an originally input image, and determinations of color, color combinations, brightness, hue, saturation, and image complexity. One method of the invention according to this embodiment of the invention is illustrated in the flow chart of FIG. 7 where, at step 158, processor 16 recognizes receipt of an input. At step 160, processor 16 determines whether the input is an input following display of results of a search using an originally input image as the input. When it is determined as step 160 that the input is based upon an originally input image (such as selection of a new image from the search results or a subsequent filtering operation using user interface 116, for example), processing advances to step 162 and processor 16 uses information corresponding to both the originally input image and the new input so that the results of the new search are constrained by aspects of the originally input image and therefore do not stray entirely away from the original image input or uploaded by the user. When, however, it is determined at step 160 that the input is not based upon an originally input image, the input is used exclusively as the basis for the search at step 164.

U.S. patent application Ser. No. 12/412,136, entitled Systems and Methods for Organizing, Displaying and Distributing Digital Images and Selling Related Items, filed Mar. 26, 2009 and assigned to Olive Root, LLC, the same assignee of the present invention, which is incorporated herein by reference in its entirety, specifies the creation and distribution of a virtual gallery of digital images. In accordance with the present invention, additional images of home décor items may be included in a gallery to create a décor collection. For example, a user may create a gallery to display décor items for a bedroom (including home décor items such as bedding, pillows, a bed, bedside tables, lamps, a rug, and window treatments). Various of these home décor items may come from different sources 24. Additionally, a creator of a gallery may tag the gallery with text tags (such as, in this example, “bedroom”, “bed”, “bedding”, etc.) and, additionally, may label or tag the gallery with one or more themes. For example, if the home décor items for the bedroom décoration or makeover presented in the gallery correspond to an island theme, then the gallery creator may wish to apply labels or tabs such as “island”, “beach”, “ocean”, “sand”, “sea”, “palm tree”, etc. Additionally, using privacy controls, the gallery creator may publish the gallery, make it viewable only by permission or to those with viewing privileges (such as friends in a social network), or may make it private. When the gallery is non-private, the gallery is part of the database 22 made available to the search engine of the present invention. Accordingly, visual inputs that correspond with the gallery will result in the gallery be retrieved in search results. Additionally, the tags and labels are useful for text-based searches on the website 18, such that text queries that match the tags or labels of a gallery will result in a non-private gallery being produced in search results to those with privileges to see the gallery (which includes the public at large for galleries with no privacy setting). Additionally, visitors to website 18 can browse non-private galleries. Additionally, visitors to a gallery can select items to link to additional information and to a webpage at which the item may be purchased.

Additionally, in an embodiment of the invention, a shopping cart is provided at website 18 that enables all items in a gallery to be added to the cart and purchased simultaneously or for selected home décor items in the cart to be selected and added to the cart for simultaneous purchase, even when the items are from different sources 24. A single electronic payment is made to a source associated with the website 18 of the present invention for the retail purchase of the items and then the source associated with website 18 electronically submits orders to the various sources 24 and pays each source 24 the corresponding wholesale amount for the items purchased. Such a process may use split payment technology, such as parallel payments from PayPal and flexible payment services from Amazon.

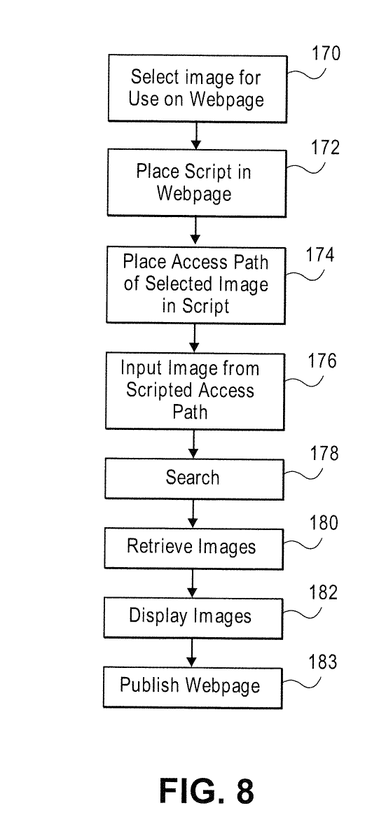

With reference now to FIG. 8, a method of the present invention for distributing the search engine capabilities of the present invention and for enabling a website to be built using the search engine methods of the present invention is illustrated and described.

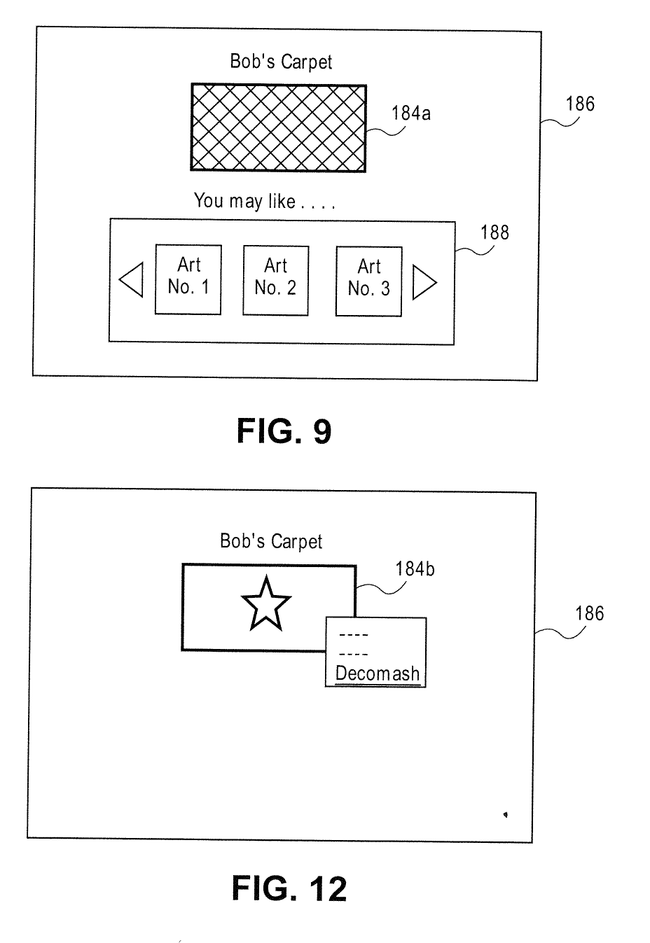

At step 170, a web developer or webmaster developing or managing a website selects an image for use on a web page of the website. For example, with additional reference to FIG. 9, a webmaster of a website for a retail store that sells carpets and rugs may select an image 184a, of a carpet that the store offers for sale, for display on a web page 186. The web master then uses the method of the present invention illustrated in FIG. 8 to find and display additional home décor items, such as artwork, that compliment the displayed image 184a of a carpet. In particular, at step 172 of FIG. 8, the web master places a script of the present invention into the markup of the webpage 186. Using the script, an image access path for the image 184a is placed in the script at step 174. At step 176, the image 184a is uploaded into server 16 to be used as an input of the search engine of the present invention. At step 178, the processor 16 deploys the search engine of the present invention and retrieves images from database 22 according to the input and search criteria. At step 180, images are retrieved. At step 182, at least a portion of the retrieved images are communicated from server 16 for display on the webpage 186. At step 183, the webpage 186 is published. As illustrated in FIG. 9 by display area 188, the script of the present invention may enable a visitor to the webpage 186 to swipe or scroll through additional images that are part of the search results but not initially displayed within the display area 188. Additionally, in accordance with the invention, the webmaster may use API's or scripts available from the source of the search engine website 18 to deploy the graphical user interfaces described herein for visual input and use in finding additional home décor items. Additionally, it should be understood that any website that provides images, not just websites in the field of home décor, can be a source of décorating inspiration and employ the script and methods of the present invention. For example, photo sharing sites and social network sites, which have volumes of images, may employ the methods of the present invention for enabling visitors and users of their sites to use images as inspiration for a search of home décor items.

This, the method of the invention described in conjunction with FIGS. 8 and 9 generates web traffic for a source associated with the images displayed in display area 188. In particular, a visitor to webpage 186 may select an image in display area 188 (such as by clicking it with a mouse or tapping on a touch screen) from a device 14 and be navigated via a web browser to a website of a source 24 associated with the selected image. Such navigation may redirect the initial link from device 14 to webpage 186 to the website of source 24 or, preferably, a new browser tab may be opened to navigate to the website of the source 24. Navigation to the source 24 from webpage 186 is made via processor 16 to enable an accounting of the click-through for statistical tracking purposes and, where applicable, to receive a fee for generating traffic to the source 24 or to electronically alert source 24 to the possibility of paying an affiliate commission upon a purchase of an item at source 24 resulting from the traffic generated to its site.

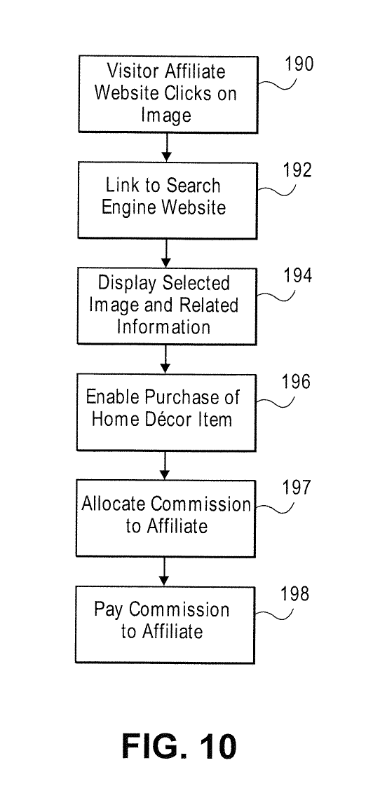

With additional reference to FIG. 10, a flow chart of an affiliate marketing program of the present invention using the method described in conjunction with FIGS. 8 and 9 is illustrated and described.

In particular, according to this aspect of the invention, a source associated with webpage 186 (“Bob's Carpet) becomes an affiliate of a source associated with the search engine website 18 of the present invention and, thus, the website that comprises webpage 186 is considered an affiliate website. At step 190, a visitor to webpage 186 selects one of the images in image display area 188 resulting, as indicated at 192, in a link to processor 16 associated with the search engine website 18 for capturing the event and redirecting the link to a source 24 associated with the selected image 22. The source 24 of the selected image displays, via its associated website, the selected image and related information, as indicated at step 194, and enables the online purchase of a home décor item (such as a piece of artwork related to the selected image), as indicated at step 196. At step 197, a commission for the generated sale is allocated. At step 198, source 24 pays the commission for the generated sale. In particular, the generated commission may be paid to the source of search engine website 18 and traffic generator of the present invention who then allocates a portion of the commission to an account of the affiliate source associated with affiliate webpage 186. Commission payments may be made at periodic times in conventional fashions and commission payout, both from source 24 to the source of website 18 as well as from the source of website 18 to the source of webpage 186, may be subject to established minimum balances. Commission allocations may be based solely on a fee for generated traffic, solely on a fee corresponding to a completed purchase, or a combination of a traffic generation fee and a fee for a completed purchase.

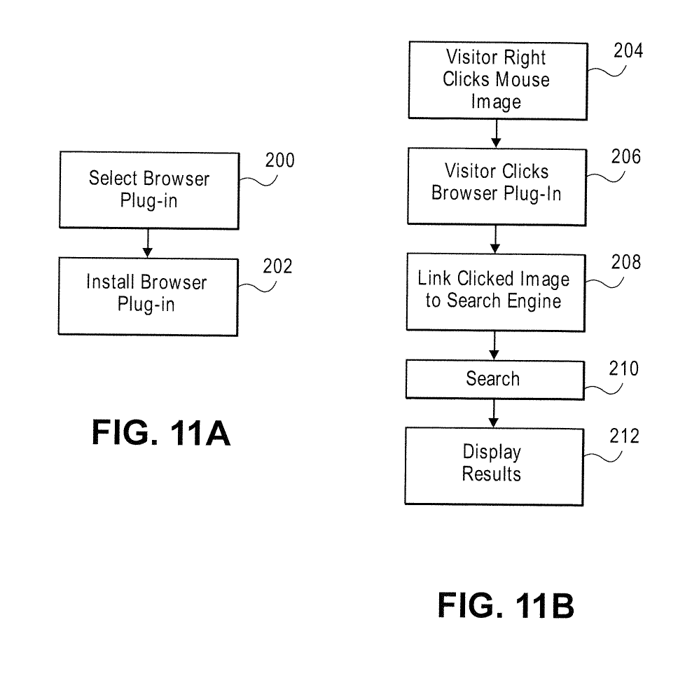

With reference now to FIGS. 11a, 11b and 12, a method for distributing the search engine methods of the present invention that employs a browser plug-in is illustrated and described.

In FIG. 11a, at step 200, a visitor to website 18 of the present invention (or other website at which it is offered) selects to install a browser plug-in to enable input of an image from a remote website into the web search engine of website 18 of the present invention. At step 202, the selected browser plug-in is installed in browser software on a device 14 of the visitor.

With additional reference to FIGS. 11b and 12, once installed, the browser plug-in enables the user to right click on an image on a website and upload that image to the visual search engine website 18 of the present invention. In particular, at step 204 of FIG. 11b, a visitor to a web page, such as web page 186 (illustrated in FIG. 12, again using “Bob's carpet” as an example), right mouse clicks (or the equivalent thereof) on the image 184b resulting in a pop-up box 185 that includes browser plug-in functions, including the browser plug-in 187 labeled “decomash” of the present invention. At step 206, the visitor selects (such as by a mouse click or equivalent) the browser plug-in 187, resulting in a link and an input of the image 184b to visual search engine website 18 at step 208. At step 210, processor 16 performs the visual search methods of the present invention to search database 22 using the image 184b. At step 212, processor 16 displays via website 18 the results of the search using image 184b where, as described herein, those results are images of home décor items.

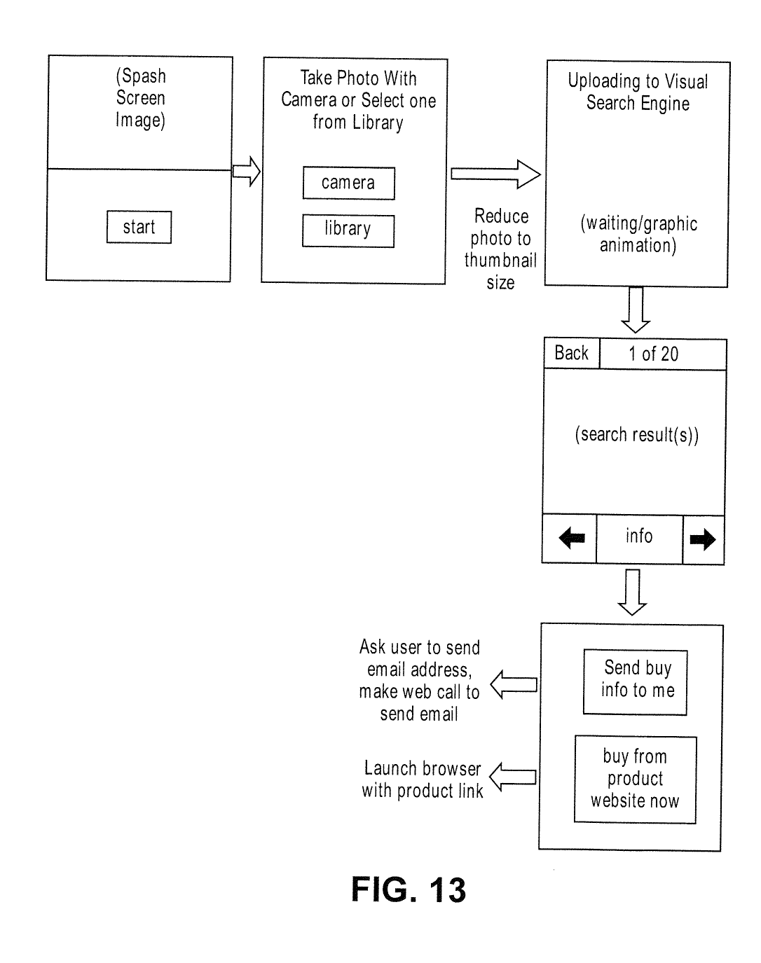

With reference now to FIG. 13, a mobile software application and related method are illustrated and described.

The mobile software application as illustrated in FIG. 13 enables a user of an Internet-enabled mobile device (such as a mobile phone or tablet) to upload an image stored in the mobile device or to take a digital photo using a camera function of the device and upload it to the visual search engine of the present invention. As illustrated, search results are displayed on the mobile device and the user is given the opportunity to obtain additional information or buy a product corresponding to a returned result.

From the foregoing it will be seen that this invention is one well adapted to attain all ends and objects hereinabove set forth together with the other advantages which are obvious and which are inherent to the described processes, methods and structure. It will be understood that the present invention provides a useful digital tool or set of digital tools to enable progressive, dynamic searching using decorative theory from a visual input. It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense. For example, although the present invention has been described as accessible via a website accessible via a browser, it will be understood that features of the present invention may be employed within a software application running on a computing device, such as a personal computer, digital photo frame, mobile device, television, etc. It will also be appreciated that spiders and web crawlers and similar technologies can be used to search the Internet for results beyond a search of database 22.

1. A computer-implemented method for finding decorative items, said method comprising:
receiving, at an electronic processor, a plurality of digital images for indexing, wherein each said digital image of said plurality of digital images is comprised of pixels and has color attributes and corresponds to a home décor item that is available for purchase;
indexing, with the aid of an electronic processor, said digital images by said color attributes to create an index of said digital images;
storing said index and said plurality of indexed images in a database;
providing a code string to enable a webmaster of a remote website to use said code string to enable visitors to said website to search for images that complement said image displayed on said website, wherein said website uses a language;
receiving an input digital image that has been input to initiate a search, wherein said input digital image is comprised of pixels and has color attributes, wherein said receiving said input digital image comprises receiving said input digital image via a widget utilizing said code string embedded into said language of remote website, wherein said received input digital image is displayed on said remote website;
using said color attributes of said received input digital image, searching for digital images in said database of digital images that have color attributes that are visually complementary to the color attributes of said received input digital image; and
causing the images found in said searching to be displayed.

2. A computer-implemented method for finding decorative items, said method comprising:
receiving, at an electronic processor, a plurality of digital images for indexing, wherein each said digital image of said plurality of digital images is comprised of pixels and has color attributes and corresponds to a home décor item that is available for purchase;
indexing, with the aid of an electronic processor, said digital images by said color attributes to create an index of said digital images;
storing said index and said plurality of indexed images in a database;
providing a downloadable browser plugin to enable input of an image from a remote website;
receiving a request to download said browser plugin;
receiving an input digital image that has been input to initiate a search, wherein said input digital image is comprised of pixels and has color attributes, wherein said receiving said input digital image comprises receiving said input digital image via said downloaded browser plug-in, wherein said received input digital image is displayed on said remote website;
using said color attributes of said received input digital image, searching for digital images in said database of digital images that have color attributes that are visually complementary to the color attributes of said received input digital image; and
causing the images found in said searching to be displayed.

3. The method as set forth in claim 2, wherein said receiving said input digital image via said downloaded browser plugin comprises receiving said input digital image from said remote website based upon a visitor to said remote website selecting to use said browser plugin on said digital image displayed on said remote website.
